(19) United States
(12) Patent Application Publication
(10) Pub. No.: US 2008/0159716 A1
(43) Pub. Date: Jul. 3, 2008

(54) Storage Medium Storing Information for Automatic Reproduction of Playlist, and Apparatus and Method for Reproducing the Storage Medium

(75) Inventors: Kwang-Min Kim, Anyang-si (KR); Du-Hee Lee, New York, NY (US)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwin-si (KR)

(21) Appl. No.: 11/720,392

(22) PCT Filed: Nov. 29, 2005
(86) PCT No.: PCT/KR05/04028

§ 371 Date: Jun. 19, 2007

(30) Foreign Application Priority Data
Nov. 29, 2004 (KR) 10-2004-0098698

(51) Int. Cl. H04N 7/26

(52) U.S. Cl. 386/124; 386/E05.001

(57) ABSTRACT

A storage medium that stores multimedia data for video reproduction and programming, and an apparatus and method for reproducing the multimedia data. The storage medium includes reproduction mode data having video data; program data having a plurality of program applications that provide interactions with a user and/or additional functions, using the video data; and an application object that manages execution of the program data, reproduction of the reproduction mode data, and automatic reproduction of a part of the reproduction mode data prior to the execution of the program data and that, when executed by a reproduction apparatus, cause the reproduction apparatus to display the video data and execute the program application.

### TECHNICAL FIELD

The present invention relates to reproduction of multimedia data, and more particularly, to a storage medium that stores multimedia data for video reproduction and programming, and an apparatus and method for reproducing the multimedia data from the storage medium.

### BACKGROUND ART

FIG. 1 is a view illustrating the structure of conventional multimedia data for video reproduction. Referring to FIG. 1, the multimedia data for video, such as a high-definition movie, includes video data 3 and 4, navigation data 2, and system data 1. As illustrated in FIG. 1, the multimedia data may be divided into four layers.

First, the system data 1 on a fourth layer is realized as an index table that includes startup information indicating information regarding a movie object to be first reproduced when a storage medium, such as a disc, is loaded into a reproducing apparatus; and information regarding a plurality of titles. The index table is an uppermost-layer table that defines the titles and a menu and further specifies the starting points of the plurality of the titles and the menu. When a new title is selected according to a user's input or a navigation command or selected from the menu, the reproducing apparatus reads the information regarding the titles from the index table and reproduces video based on the read information.

The navigation data 2 on a third layer is realized as a plurality of movie objects 20 that include navigation commands for video data reproduction. The navigation commands are used to begin reproduction of lower-layer playlists 3, which will later be described in detail, move the reproducing position between the movie objects 20, or manage reproduction of the playlists 3 according to a user's preference. The playlists 3 on a second layer define reproduction units in which the video data is reproduced. The video data is recorded in continuous regions of a storage medium in units of clips which will later be described in detail. Each playlist 3 indicates a reproduction unit corresponding to a portion of a clip or a plurality of clips to be reproduced at a time. Each playlist 3 includes a plurality of playitems that are sub-reproduction units. A playitem designates a section to be reproduced in a part of a clip or a plurality of clips. The playlist 3 may be determined such that a plurality of playitems are sequentially reproduced or a predetermined playitem, which is selected from among the playitems by a user or has been predetermined in the reproducing apparatus, is selectively reproduced.

Lastly, each of clips 4 on a first layer defines units in which the video data is recorded. Each clip 4 is comprised of a clip AV stream and a clip information file. The clip AV stream includes audio, video, sub titles, graphics data, and so on. The clip information file specifies the attributes of the clip AV stream and includes an entry point map that allows conversion of reproduction time information into byte address information.

### DISCLOSURE OF INVENTION

### Technical Problem

The above multimedia data is mainly used to simply reproduce video according to a content manufacturer's intention. However, in recent years, a need for various interfaces with a user or various additional services (game services, etc.), has also been increased. Accordingly, program applications that provide various interactions with a user and/or additional functions using a C-language, Java, HTML, or a script language, are needed to be provided together with video.

In the mean time, an application, such as a Java application, requires a time for initialization, thus significantly increasing a user's waiting time. Specifically, in order to reproduce only multimedia data, the multimedia data can be immediately read and reproduced after selecting a playlist to be reproduced. However, when multimedia data is reproduced by running an application, a playlist must be read to reproduce the multimedia data after performing initialization and executing the application, thereby increasing a user's waiting time.

Further, when an application that reproduces multimedia data on a part of a screen is executed, the multimedia data is reproduced in a full screen mode at first, and then the screen is adjusted to a smaller size, thereby causing an unnatural screen change and the user's inconvenience.

### Technical Solution

The present invention provides a storage medium that stores multimedia data for video reproduction and programming, and an apparatus and method for reproducing the multimedia data.

The present invention also provides a storage medium that stores multimedia data containing information for automatic reproduction of a playlist, thus reducing a user's waiting time, and an apparatus and method for reproducing the multimedia data.

The present invention also provides a storage medium that stores multimedia data containing information that prevents a sudden screen change, and an apparatus and method for reproducing the multimedia data.

### ADVANTAGEOUS EFFECTS

As described above, the present invention provides a storage medium that stores multimedia data that contains information for automatic reproduction of a playlist, and an apparatus and method for reproducing the multimedia data.

According to the present invention, a playlist is automatically reproduced using information for automatic reproduction of the playlist before an application is initialized and executed, and then, the execution of the application is controlled, thereby reducing a user's waiting time. Further, the starting point and scale of video are set prior to the execution of the application, based on information regarding the starting point and scale of the playlist, the information being included in the information for automatic reproduction of the playlist. Accordingly, it is possible to prevent an unnatural screen change caused by changing the scale and location of video according to the purpose of the application after the execution of the application.

While this invention has been particularly shown and described with reference to exemplary embodiments thereof, it will be understood by those skilled in the art that various changes in form and details may be made therein without departing from the spirit and scope of the invention as defined by the appended claims.

### DESCRIPTION OF DRAWINGS

The above and other aspects and advantages of the present invention will become more apparent by describing in detail exemplary embodiments thereof with reference to the attached drawings in which:

FIG. 1 is a view illustrating the construction of conventional multimedia data for video reproduction;

FIG. 2 is a view illustrating the construction of multimedia data for video reproduction and programming according to an embodiment of the present invention;

FIG. 3A is a view illustrating the construction of an application object that contains information for automatic reproduction of a playlist, according to an embodiment of the present invention;

FIG. 3B is a view illustrating the construction of an application object that contains information for automatic reproduction of a playlist, according to another embodiment of the present invention;

FIG. 4A is a view illustrating a conventional screen change;

FIG. 4B is a view illustrating a screen change performed by using information for automatic reproduction of a playlist according to an embodiment of the present invention;

FIG. 5 is a block diagram illustrating the construction of a reproducing apparatus according to an embodiment of the present invention; and

FIG. 6 is a flowchart illustrating a video reproduction method according to an embodiment of the present invention.

### BEST MODE

According to an aspect of the present invention, there is provided a storage medium comprising reproduction mode data for reproduction of video data; program data having a plurality of program applications which provide interactions with a user and/ or additional functions using the video data; and an application object managing execution of the program data and reproduction of the reproduction mode data, and automatic reproduction of a part of the reproduction mode data before the execution of the program data. Also, the reproduction mode data may be managed in units of playlists, and the application object may include application information for managing the execution of the program data in units of titles, and information regarding at least one playlist to be reproduced when the program data is executed.

The application object may further comprise information regarding a playlist to be automatically reproduced prior to the execution of the program data.

The application object may further comprise information regarding a starting point and/or a scale of the playlist to be automatically reproduced.

According to another aspect of the present invention, there is provided a reproducing apparatus including a reader reading an application object from a storage medium which stores reproduction mode data for reproduction of video data, program data having a plurality of program applications which provide interactions with a user and/or additional functions using the video data, and the application object managing execution of the program data, reproduction of the reproduction mode data, and automatic reproduction of a part of the reproduction mode data prior to the program data; and a controller controlling the execution of the program data and reproduction of the reproduction mode data, and the automatic reproduction of a part of the reproduction mode data prior to the execution of the program data, based on the application object.

According to another aspect of the present invention, there is provided a reproducing method comprising reading application data from a storage medium which stores reproduction mode data for reproducing video data; program data containing a plurality of program applications which provide interactions with a user and/or additional functions, using the video data; and an application object managing execution of the program data, reproduction of the reproduction mode data, and automatic reproduction of a portion of the reproduction mode data prior to the execution of the program data; and controlling the execution of the program data, the reproduction of the reproduction mode data, and the automatic reproduction of a portion of the program data prior to the execution of the program data, based on the application object.

According to another aspect of the present invention, there is provided a computer readable storage medium on which a program that includes commands for executing the operations of the above method in a computer is recorded.

### MODE FOR INVENTION

A storage medium according to an embodiment of the present invention includes not only a movie object for video reproduction but also an application object for programming functions. The application object contains information for automatic reproduction production of a playlist, thus reducing a user's waiting time, and the information for automatic reproduction may include information that prevents a sudden screen change.

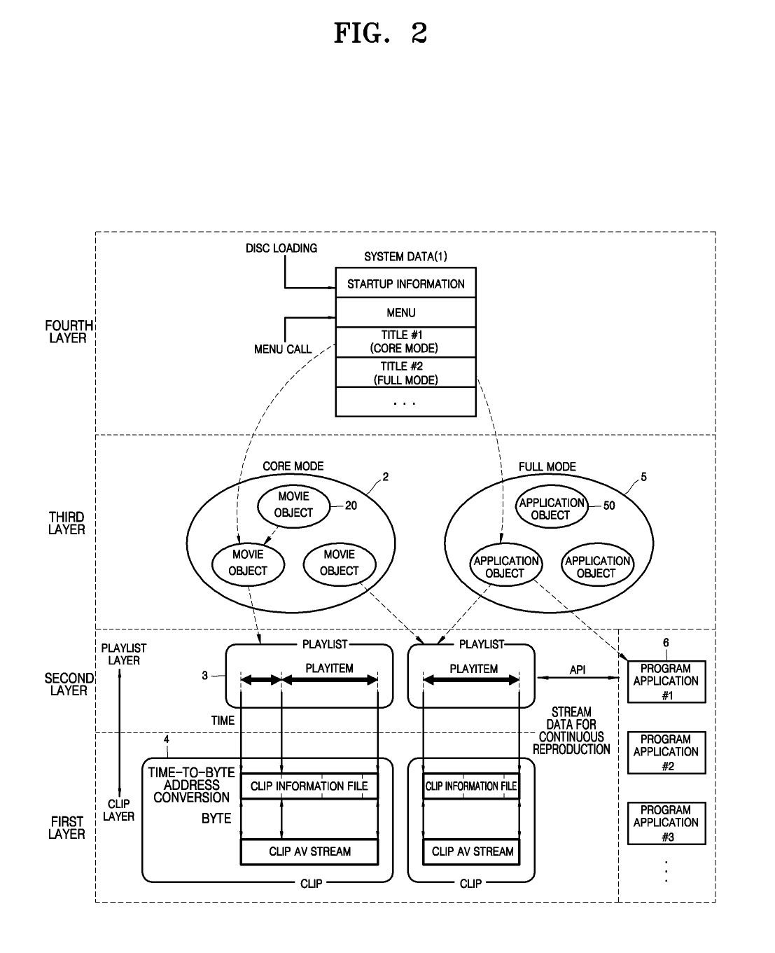

More specifically, the construction of a data stored in a storage medium according to an embodiment of the present invention will now be described with reference to FIG. 2. FIG. 2 is a view illustrating the construction of multimedia for video reproduction and programming according to an embodiment of the present invention.

Referring to FIG. 2, the multimedia data includes video data 3 and 4, navigation data 2, and system data 1, and is divided into four layers. The multimedia data further includes a plurality of program applications 6 and full-mode navigation data 5 for programming functions. The full-mode navigation data 5 includes a plurality of application objects 50.

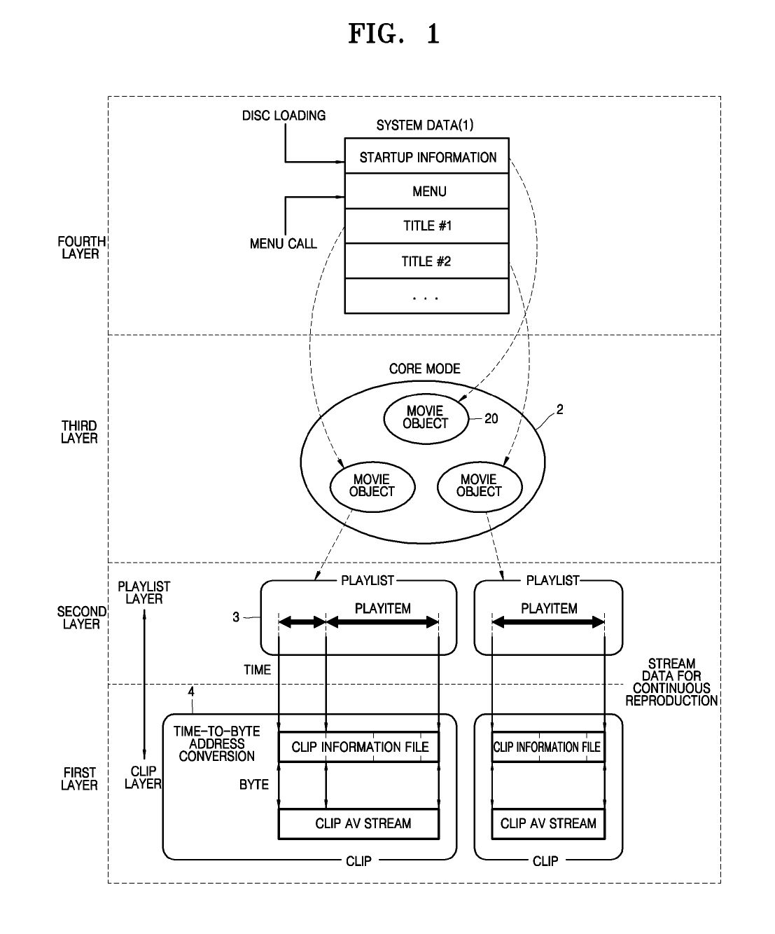

For general video reproduction, a playlist 3 is read to learn a reproduction order and time by using a navigation command stored in a movie object 20, as described with reference to FIG. 1. Also, reproduction time information is transformed into byte address information by reading a clip information file of a clip 4 corresponding to the reproduction time according to the reproduction order. Then, video is reproduced by reading a clip AV stream, of a clip 4, which corresponds to the byte address information. In this disclosure, a mode in which video is simply reproduced according to a time order designated by a manufacturer will be referred to as a ‘core mode’ or a ‘movie mode’, and a mode in which an application with a programming function is reproduced together with video will be referred to as a ‘full mode’.

The multimedia data according to an embodiment of the present invention may further include a plurality of program applications 6 and a plurality of application objects 50 for the full mode. In other words, the multimedia data includes not only the movie objects 20 for simple video reproduction but also the application objects 50 with the programming function. Thus, in the full mode, an application can provide an interaction with a user and an additional function while reproducing the entire video or a part thereof, using an application program interface (API) for a playlist. That is, particular information may be provided or a predetermined one of the program applications 6 may operate in synchronization with a specific scene of a movie.

For instance, when a user clicks a mobile phone appearing in a scene of the movie ‘Matrix’, an advertising application of a manufacturing company that manufactured the mobile phone may operate automatically. Also, in a spectacular scene of the movie ‘The Lord of the Rings’ that presents the beautiful scenery of a mountain covered with snow, the program application 6 that provides a description, travel information, and a travel event regarding the mountain may operate automatically.

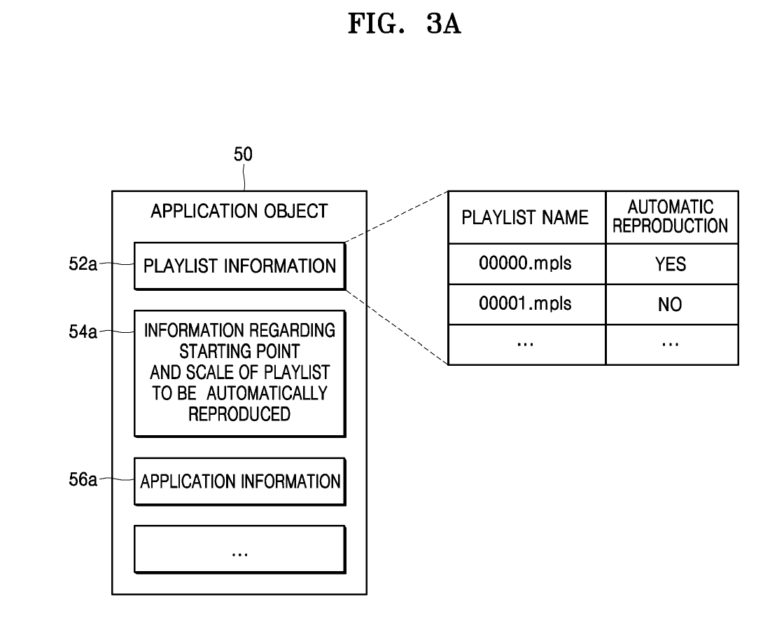

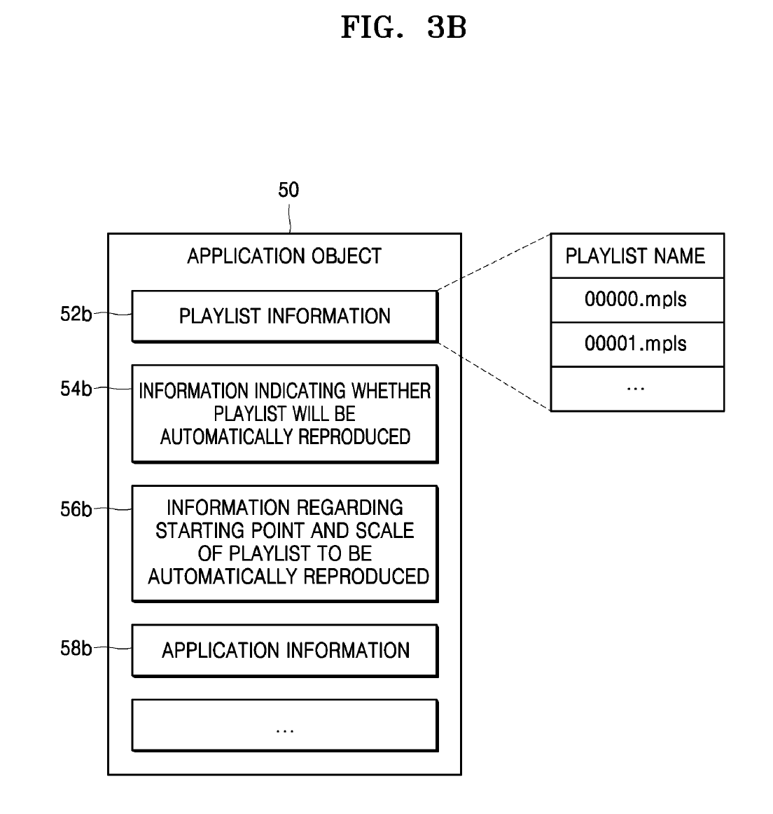

FIG. 3A is a view illustrating the construction of an application object 50 that contains information for automatic reproduction of a playlist, according to an embodiment of the present invention. FIG. 3B is a view illustrating the construction of an application object 50 that contains information for automatic reproduction of a playlist, according to another embodiment of the present invention.

Referring to FIG. 3A, the application object 50 contains playlist information 52a, information 54a for automatic reproduction of a playlist, and application information 56a. The application object 50 may further include additional information.

In conventional storage media, video data is recorded so that it is reproduced in units of titles according to a content manufacturer's intention. In a storage medium according to an embodiment of the present invention, video data and application data are also recorded so that they are reproduced in units of titles. Titles are categorized into core mode titles that contain only video data, and full mode titles that contain both video data and application data, according to the type of multimedia data contained.

The core mode title has the same structure as a title stored in a conventional storage medium.

A full mode title is comprised of at least one program application, and a playlist of video data to be reproduced by executing an application. Referring to FIG. 2, the movie object 20 included in a core mode title controls reproduction of video using a playlist that is predetermined by a manufacturer using a navigation command. In contrast, in a full mode title, reproduction of video is controlled by the program application 6, and thus, a navigation command for video reproduction is not required.

However, the playlist information 52a for reproducing video data, and the application information 56a for control of the operation of the program application 6 are needed.

In the present embodiment, the application object 50 contains the information 54a for automatic reproduction of a playlist, thus reducing a user's waiting time.

More specifically, the playlist information 52a presents a list of playlists regarding video data in a title. To reproduce the entire movie or a part thereof, the program application 6 reads the list of the playlists 3 indicating a clip AV stream, which is to be reproduced, from among clip AV streams which is high-definition video data stored in a storage medium, and reproduces corresponding video data. In particular, the playlist information 52a is not included in the program application 6 for a full mode but is separately managed by the application object 50, thereby achieving independence in the manufacture of applications and easy reuse of manufactured applications.

The application information 56a specifies particulars for execution of program applications. For instance, the application information 56a includes information regarding the attributes (location, name, version, etc.) of each program application; information for controlling the life cycle (starting, pausing, ending) of each program application; pre-load information, and pre-fetch information. Also, the application object 50 may include information regarding a playlist to be automatically reproduced when the application object 50 is initially executed without respect to whether the program application 6 is executed, thereby reducing a user's waiting time. The information regarding the playlist to be automatically reproduced may include the information 52a regarding the playlist to be automatically reproduced, and the information 54a regarding the starting point and scale regarding the playlist to be automatically reproduced. The information 54a regarding the starting point and scale is needed to prevent a sudden screen change.

Referring to FIG. 3A, in another embodiment, the playlist information 52a includes a list of playlists to be reproduced when a corresponding application is executed, and specifies whether each playlist will be automatically reproduced. Playlists, which are set to be automatically reproduced, which are listed in the list of the playlists are auto- matically reproduced prior to execution of the application. Accordingly, a user can view video even during initialization of the application, thereby reducing the user's waiting time.

In general, when an application that reproduces multimedia data on a part of a screen is executed, the screen size is changed during reproduction of the multimedia data in a full screen mode, thereby causing an unnatural screen change and the user's inconvenience. However, it is possible to reproduce video in a predetermined size at a predetermined position without a sudden screen change by using the information 54a regarding the starting point and scale of the playlist to be automatically reproduced.

FIG. 3B is a view illustrating the construction of the application object 50 according to another embodiment of the present invention. Referring to FIG. 3B, the application object 50 contains playlist information 52b that includes a list of playlists to be reproduced simultaneously with execution of a corresponding application, and separately includes information 54b indicating whether the playlists in the list will be automatically reproduced. If the information 54b indicating whether the playlists will be automatically reproduced is set to ‘ON’, a first playlist listed in the list included in the playlist information 52b is automatically reproduced. The application object 50 further contains information 56b regarding a starting point and scale of each playlist to automatically reproduced, and application information 58b, which have been described with reference to FIG. 3A.

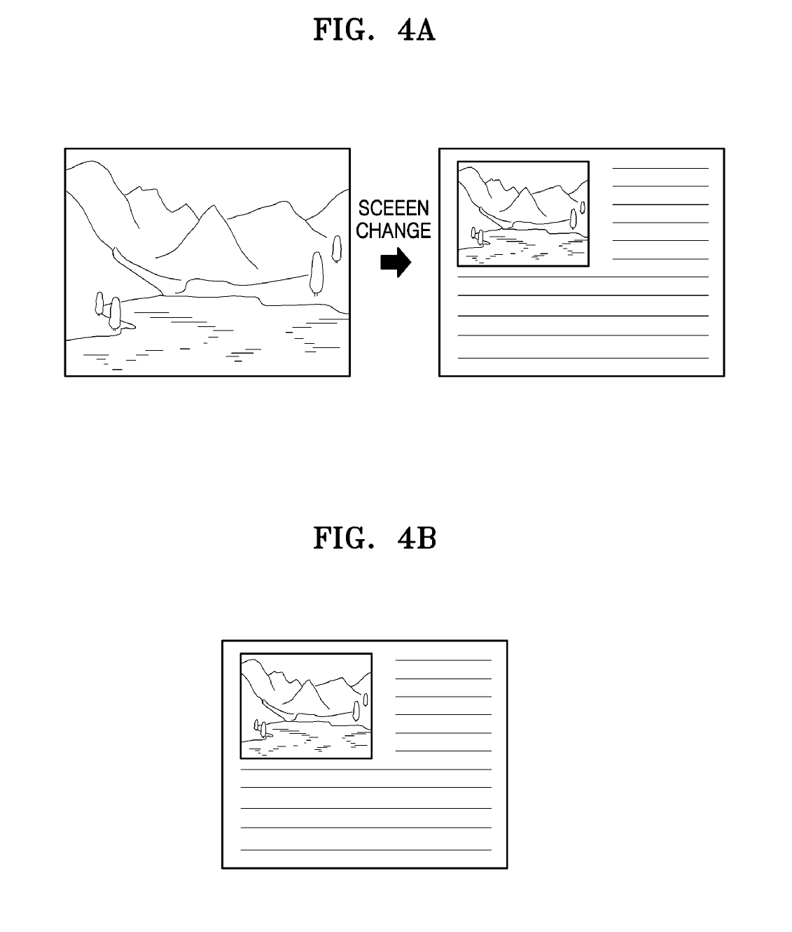

FIG. 4A is a view illustrating a conventional screen change. FIG. 4B is a view illustrating a screen change performed by using information for automatic reproduction of a playlist according to an embodiment of the present invention.

Specifically, FIG. 4A illustrates a conventional method of reproducing video by executing an application. Referring to FIG. 4A, when the application is executed, a screen size is changed during reproduction of multimedia data in a full screen mode, thereby causing an unnatural screen change and a user's inconvenience.

FIG. 4B illustrates a screen change by using an application object 50 of FIG. 3A or 3B, according to an embodiment of the present invention. Referring to FIG. 4B, a playlist to be automatically reproduced can be immediately reproduced in a predetermined size at a predetermined position of a screen, based on the information 54a or 56b regarding the starting point and scale of the playlist, included in the application object 50. Therefore, it is possible to prevent a sudden screen change as illustrated in FIG. 4A.

An apparatus and method for reproducing multimedia data from a storage medium according to an embodiment of the present invention will now be described.

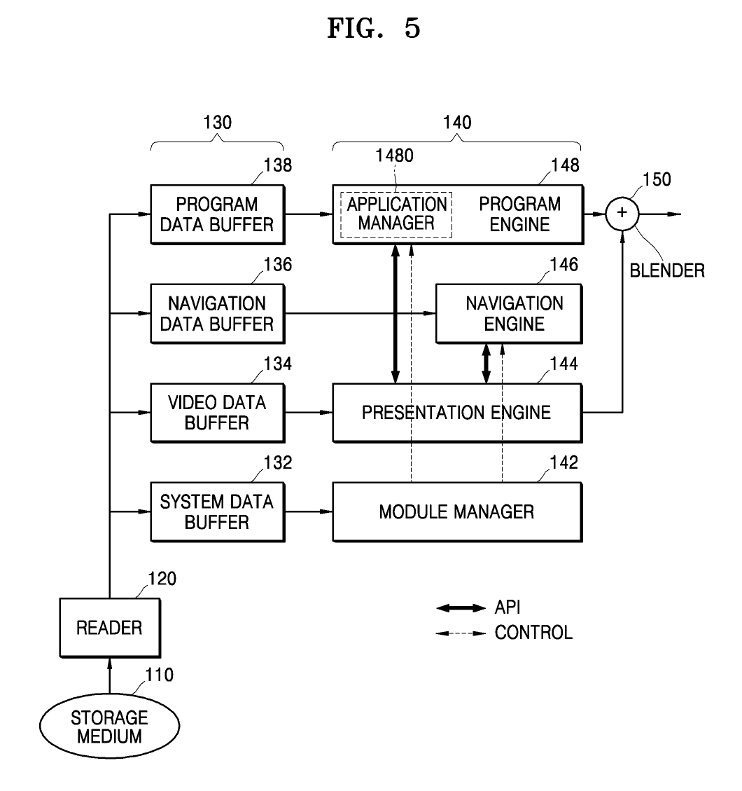

FIG. 5 is a block diagram illustrating the construction of a reproducing apparatus according to an embodiment of the present invention. Referring to FIG. 5, the reproducing apparatus includes a reader 120 that reads data from a storage medium 110; a buffer unit 130 that temporarily stores the read data; a module manager 142 that reads system data, performs initialization and controls a navigation engine 146 to process a title change caused by a user's selection or a navigation change; the navigation engine 146 that controls reproduction of video based on navigation data;

and a presentation engine 144 that decodes video data and displays the decoding result on a screen (not shown).

The reproducing apparatus further includes a program engine 148 that executes a program application, and a program data buffer 138. Alternatively, a plurality of program engines may be used according to the type of an application. For instance, to execute a Java application and a HTML application together, both a Java virtual machine that executes the Java application and a browser engine that executes the HTML application are required. Also, the reproducing apparatus further includes a blender 150 that constructs a screen display by overlaying a result of performing an application by the program engine 148 and a result of reproducing video data by the presentation engine 144.

Further, the program engine 148 may include an application manager 1480 that controls execution of the program application 6 of FIG. 2 using the application object 50 of FIG. 3A or 3B in order to provide a programming function. Specifically, the application manager 1480 reads the playlist information 52a (or 52b), the information 54a (or 54b and 56b) for automatic reproduction of a playlist, and application information 56a (or 58b), and controls execution of the program application 6. In the present embodiment, the module manager 142 and the application manager 1480 are separately constructed, but they may be integrated as one module that performs both the operations of the module manager 142 and the application manager 1480.

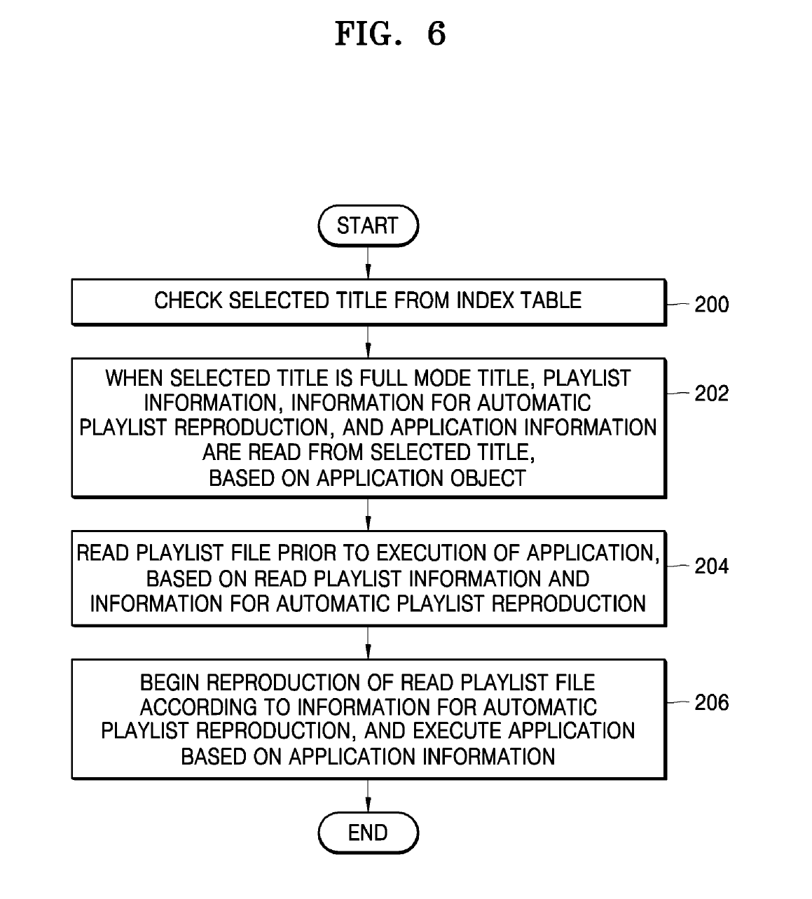

Hereinafter, a method of reproducing multimedia data from a storage medium by the reproducing apparatus illustrated in FIG. 5 will be described. FIG. 6 is a flowchart illustrating a video reproduction method according to an embodiment of the present invention.

Referring to FIGS. 2, 5, and 6, the reader 120 reads multimedia data from the storage medium 110 and stores the read multimedia data in the buffer unit 130. The buffer unit 130 includes 4 buffers for storing different types of data included in the read multimedia data respectively. Program data is stored in the program data buffer 138, navigation data is stored in a navigation data buffer 136, video data is stored in a video data buffer 134 and system data is stored in a system data buffer 132. The reader 120 reads out the system data (index table) 1 on the fourth layer, shown in FIG. 2, to the system buffer 132 and transmits it to the module manager 142. The module manager 142 acquires information regarding a title selected by a user or according to the order of reproduction from the system data 1. If the selected title is a core mode title, the module manager 142 transmits the movie object 20 or the application object 50 to the navigation engine 146. If the selected title is a full mode title, the module manager 142 transmits the movie object 20 or the application object 50 to the program engine 148. Then, the navigation engine 146 or the program engine 148 interprets the received movie object 20 or the application object 50, and decodes and reproduces a playlist file included in the received movie object 20 or the application object 50, using the presentation engine 144. In this case, the application manager 1480 controls execution of a program application by using the application information 56a or 58b included in the application object 50.

In particular, the application manager 1480 transmits the playlist information 52a or 52b and the information 54a, 54b or 56b for automatic reproduction of a playlist, which are included in the application object 50, to the presentation engine 144, so as to reproduce a playlist that is set to be automatically reproduced before the program application is initialized and executed. Also, information regarding a starting point and scale of video corresponding to the playlist is transmitted to the presentation engine 144. Then, based on the received information, the presentation engine 144 decodes the playlist and outputs the decoding result in the predetermined scale at the starting point

1. A storage medium comprising:
video data;
program data having a plurality of program applications that provide interactions with a user and/or additional functions using the video data; and
an application object to manage execution of the program data and reproduction of the video data, and automatic reproduction of a part of the video data before the execution of the program data and that, when executed by a reproduction apparatus, cause the reproduction apparatus to display the video data and execute the program application.

2. The storage medium of claim 1, wherein:
the video data is managed in units of playlists; and
the application object comprises application information to manage the execution of the program data in units of titles and information regarding at least one playlist to be reproduced when the program data is executed.

3. The storage medium of claim 2, wherein the application object further comprises information regarding a playlist to be automatically reproduced prior to the execution of the program data.

4. The storage medium of claim 3, wherein the application object further comprises information regarding a starting point and/or a scale of the playlist to be automatically reproduced.

5. A reproducing apparatus comprising:
a reader to read an application object from a storage medium that stores and program data having a plurality of program applications that provide interactions with a user and/or additional functions using the video data, wherein the application object manages execution of the program data, reproduction of the video data, and automatic reproduction of a part of the video data prior to the program data; and
a controller to control the execution of the program data and reproduction of the video data, and to control the automatic reproduction of a part of the video data prior to the execution of the program data, based on the application object.

6. The reproducing apparatus of claim 5, wherein:
the video data is managed in units of playlists;
the application object comprises application information to manage the execution of the program data in units of titles and information regarding at least one playlist to be reproduced when the program data is executed; and
the controller controls the execution of the program data based on the application information, and allows corresponding video data to be reproduced when the program data is executed, based on the playlist information.

7. The reproducing apparatus of claim 6, wherein:
the application object further comprises information regarding a playlist to be automatically reproduced prior to the execution of the program data; and
the controller controls the playlist to be automatically reproduced before the execution of the program data based on the information regarding the playlist to be automatically reproduced.

8. The reproducing apparatus of claim 7, wherein:
the application object further comprises information regarding a starting point and/or a scale of the playlist to be automatically reproduced; and
the controller controls video data to be reproduced in a predetermined size at a predetermined location, using the information regarding the starting point and/or the scale.

9. A reproducing method comprising:
reading application data from a storage medium that stores video data program data containing a plurality of program applications that provide interactions with a user and/or additional functions using the video data, and an application object to manage execution of the program data, reproduction of the video data, and automatic reproduction of a portion of the video data prior to the execution of the program data; and
controlling the execution of the program data, the reproduction of the video data, and the automatic reproduction of a portion of the video data prior to the execution of the program data, based on the application object.

10. The reproducing method of claim 9, wherein:
the video data is managed in units of playlists;
the application object comprises application information to manage the execution of the program data in units of titles and information regarding at least one playlist to be reproduced when the program data is executed; and
the controlling of the execution of the program data comprises, controlling the execution of the program application based on the application information, and reproducing the corresponding video data when the program application is executed, based on the playlist information.

11. The reproducing method of claim 10, wherein:
the application object further comprises information regarding a playlist to be automatically reproduced prior to the execution of the program data; and
the controlling of the execution of the program data comprises, controlling the automatic reproduction of the playlist prior to the execution of the program data based on the information regarding the playlist to be automatically reproduced.

12. The reproducing method of claim 11, wherein:
the application object further comprises information regarding a starting point and/or a scale of the playlist to be automatically reproduced;
the controlling of the execution of the program data further comprises controlling the video data to be reproduced in a predetermined size at a predetermined position, based on the information regarding the starting point and/or scale.

13. A computer readable storage medium having embodied thereon a program that includes commands to execute each operation of the reproducing method of claim 9 in a computer.
